(19) United States
(12) Patent Application Publication
(10) Pub. No.: US 2009/0254482 A1
(43) Pub. Date: Oct. 8, 2009

(54) TIME-BASED LICENSES

(75) Inventors: Viswanath Vadlamani, Sammamish, WA (US); Shek Lun Ho, Sammamish, WA (US); Lazar Ivanov Ivanov, Seattle, WA (US); Caglar Gunyakti, Sammamish, WA (US); Kalin Toshev, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/099,137

(22) Filed: Apr. 7, 2008

(51) Int. Cl. H04K 1/00

(52) U.S. Cl. 705/59

(57) ABSTRACT

A method and a system are provided for issuing a number of different types of time-based licenses associated with software products. The system may include an activation server, which may maintain licensing information in a licensing database, and a licensing platform, which may request issuance and renewal of time-based licenses. Each of the time-based licenses may be associated with respective product keys and may have a number of configurable parameters, which may make the time-based licenses suitable for a number of different licensing business models. The licensing business models may include, but not be limited to, a non-renewable evaluation license, a renewable trial license, a one-time promotion license, and a subscription license. In some embodiments, a configurable parameter may indicate an amount of time for a grace period after a time-based license would have normally expired.

### BACKGROUND

Many existing licenses for using software products are perpetual licenses. That is, once a license is issued, a user may permanently use a software product associated with the license. In some cases, a user may have a contract with a software vendor giving the user the right to use a software product for a limited period of time. However, a perpetual license may be issued and installed on a user's processing device, giving the user a right to use the software product beyond the limited period of time stated in the contract.

Some existing systems issue licenses for a predetermined period of time. However, the systems are not flexible enough to issue licenses suitable for a number of different licensing business models.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a system are provided in which a number of different types of time-based licenses, associated with software products, may be issued or renewed. Properties of the time-based licenses may be affected by settings of a number of configurable parameters. The configurable parameters, along with a number of types of time-based licenses, make the time-based licenses suitable for a number of different licensing business models. Some parameters may be configurable for certain types of time-based licenses and other parameters may be non-configurable for other types of time-based licenses.

A system for issuing a number of different types of time-based licenses may include an activation server having access to a licensing database, a licensing platform accessible to a licensing application programming interface (API) and a user interface. The licensing platform may send a request for a time-based license to the activation server via a network. The request may include a product key associated with a software product. The activation server may determine a type of time-based license to issue based on information stored in the licensing database with respect to the product key included in the request. An activation response, including the time-based license, may be sent to the licensing platform, which may use the time-based license and may grant a right to use the software product for a predetermined period of time, as indicated by the time-based license.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary functional block diagram of a system consistent with the subject matter of this disclosure.

FIG. 2 illustrates a functional block diagram of a processing device, which may implement one or more components of a system consistent with the subject matter of this disclosure.

FIG. 3 is a functional block diagram of an exemplary system, which may implement embodiments consistent with the subject matter of this disclosure.

FIG. 4 is a table showing exemplary types of time-based licenses and whether specified exemplary parameters of the types of time-based licenses may be configurable in embodiments consistent with the subject matter of this disclosure.

FIGS. 5-7 are flowcharts illustrating exemplary processes which may be performed in an activation server in embodiments consistent with the subject matter of this disclosure.

FIGS. 8 and 9 are flowchart illustrating exemplary processes which may be performed in a licensing platform in embodiments consistent with the subject matter of this disclosure.

FIG. 10 illustrates exemplary time-based license commands and messages which may be displayed via a user interface in embodiments consistent with the subject matter of this disclosure.

FIG. 11 illustrates an exemplary message warning of an impending time-based license expiration and an exemplary message providing notice of an expired time-based license.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a method and a licensing system for issuing a number of different types of time-based licenses associated with a use of software products. The time-based licenses may have a number of configurable parameters, which may affect different properties of the time-based licenses, thereby making the time-based licenses flexible, such that they may be suitable for a number of different licensing business models. The licensing business models may include, for example, a non-renewable evaluation of a software product, a renewable trial of the software product, a one-time promotion of the software product, a subscription for use of the software product, or other licensing business models for use of the software product.

Although various embodiments may include one or more types of time-based licenses, in one exemplary embodiment consistent with the subject matter of this disclosure, four types of time-based licenses may be issued, a class A license, a class B license, a class C license, and a class D license. Each of the types of licenses may have an associated range of product keys. The class C license and the class D license may permit the associated product key to be changed, while the class A license and the class B license may not permit the associated product key to be changed. Further, a respective validity time period for the class B license and the class D license may be renewable, while the respective validity time period for the class A license and the class C license may not be renewable.

A number of other parameters may further be configured for each of the types of the time-based licenses and many affect various properties of the time-based licenses including, but not limited to, when the time-based license expires, whether a grace period exists after the time-based license would have normally expired, whether the time-based license permits use of the software product on the processing devices, a number of processing devices permitted to use the software product under the time-based license, whether the time-based license may be converted to a perpetual license after a specified number of activations, and a time period only during which the time-based license may be activated for the software product.

### Exemplary Environment

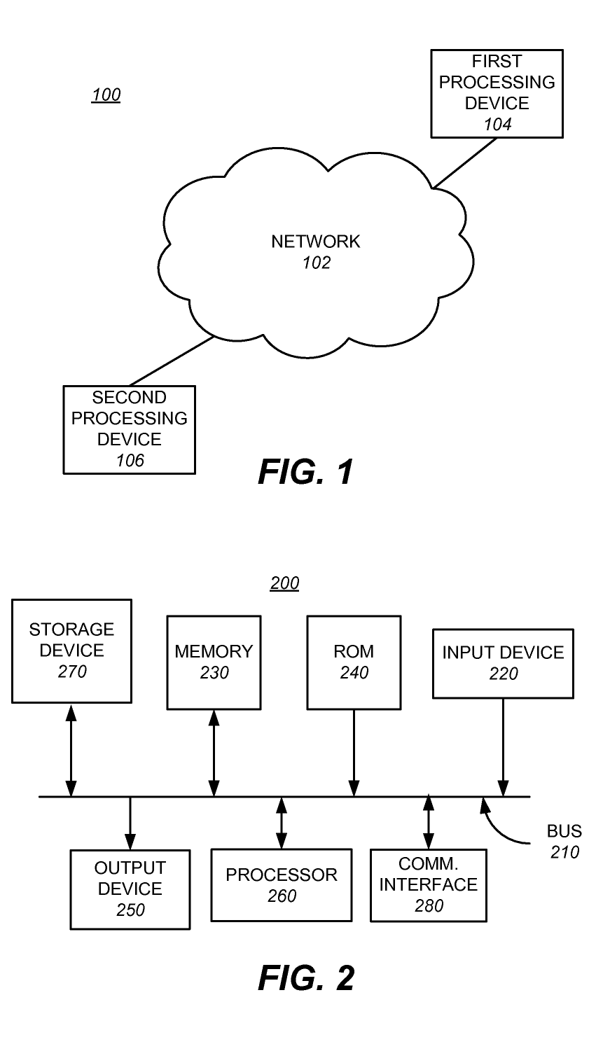

FIG. 1 illustrates an exemplary environment 100 in which embodiments consistent with the subject matter of this disclosure may operate. Exemplary environment 100 may include a network 102, a first processing device 104, and a second processing device 106.

Network 102 may be a single network or a combination of networks, such as, for example, the Internet or other networks. Network 102 may include a wireless network, a wired network, a packet-switching network, a public switched telecommunications network, a fiber-optic network, other types of networks, or any combination of the above.

First processing device 104 and second processing device 106 may be desktop personal computers (PCs), laptop PCs, handheld processing devices, or other processing devices. In one embodiment, first processing device 104 may be a server or a server farm and second processing device 106 may be a user's processing device, which may include a software product for which a license may be obtained.

### Exemplary Processing Device

FIG. 2 is a functional block diagram of an exemplary processing device 200, which may be used to implement first processing device 104 and/or second processing device 106. Processing device 200 may include a bus 210, an input device 220, a memory 230, a read only memory (ROM) 240, an output device 250, a processor 260, a storage device 270, and a communication interface 280. Bus 210 may permit communication among components of processing device 200.

Processor 260 may include at least one conventional processor or microprocessor that interprets and executes instructions. Memory 230 may be a random access memory (RAM) or another type of dynamic storage device that stores information and instructions for execution by processor 260. Memory 230 may also store temporary variables or other intermediate information used during execution of instructions by processor 260. ROM 240 may include a conventional ROM device or another type of static storage device that stores static information and instructions for processor 260. Storage device 270 may include compact disc (CD), digital video disc (DVD), a magnetic medium, or other type of storage device for storing data and/or instructions for processor 260.

Input device 220 may include a keyboard or other input device. Output device 250 may include one or more conventional mechanisms that output information, including one or more display monitors, or other output devices. Communication interface 280 may include a transceiver for communicating over one or more networks via a wired, wireless, fiber optic, or other connection.

Processing device 200 may perform such functions in response to processor 260 executing sequences of instructions contained in a tangible machine-readable medium, such as, for example, memory 230, ROM 240, storage device 270 or other medium. Such instructions may be read into memory 230 from another machine-readable medium or from a separate device via communication interface 280.

### Exemplary System

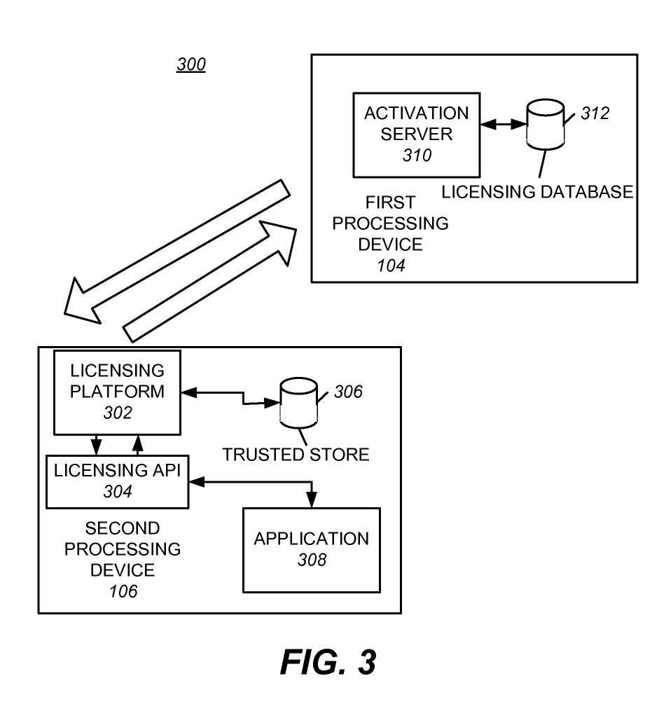

FIG. 3 illustrates an exemplary system 300 in which embodiments consistent with the subject matter of this disclosure may be implemented. System 300 may include first processing device 104 and second processing device 106. First processing device 104 and second processing device 106 may communicate with one another through network 102 (FIG. 1).

First processing device 104 may include an activation server 310 and a licensing database 312. In other embodiments, activation server 310 and licensing database 312 may reside in different processing devices. Activation server 310 may receive requests to issue and activate a time-based licenses associated with software products. Activation server 310 may obtain and update license information stored in licensing database 312.

Second processing device 106 may include a licensing platform 302, a licensing application program interface 304 (API), a trusted store 306, and an application 308.

Licensing platform 302 may communicate with activation server 310 to request issuance and activation of time-based licenses for associated software products. Received time-based licenses may be stored in a token store (not shown) and installed product keys may be stored in trusted store 306, which may include secure data storage accessible only to certain components of second processing device 106, such as, for example, licensing platform 302, as well as other components.

Application 308 may access functions of licensing platform 302 via licensing API 304. As an example, application 308 may request and receive information regarding one or more particular time-based licenses via licensing API 304. Further, application 308 may request issuance and activation of a time-based license, renewal of a time-based license, or other time-based license actions via licensing API 304.

### Exemplary Licenses

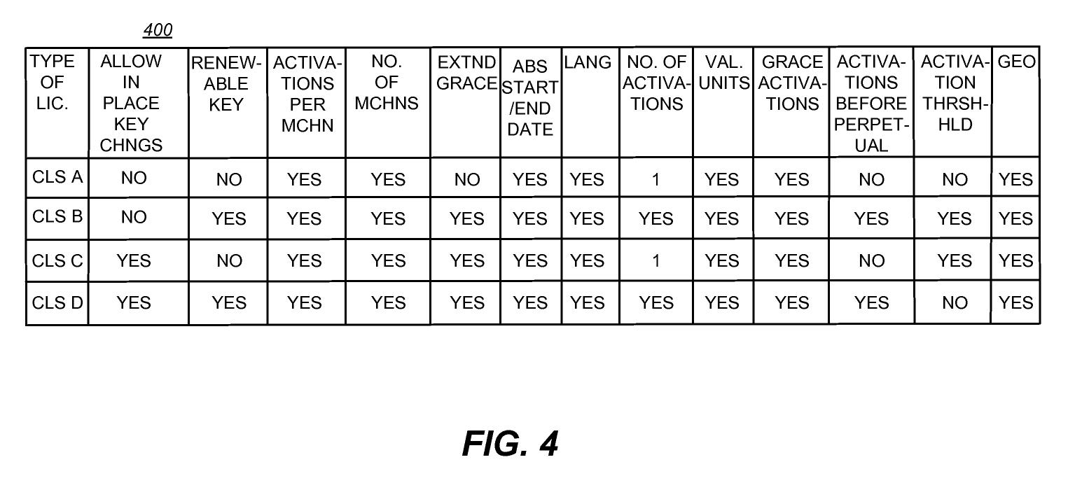

FIG. 4 is a table 400 illustrating a number of different types of time-based licenses in an embodiment consistent with the subject matter of this disclosure. According to table 400, a class C license and a class D license may permit product keys, associated with respective licenses, to be changed, while a class A license and a class B license do not permit product keys, associated with respective licenses, to be changed. The class B license and the class D license may be renewable licenses having renewable product keys, while the class A license and the class C license may be non-renewable licenses having non-renewable product keys.

Each of the types of the time-based licenses may have a number of configurable parameters, which may permit the time-based licenses to be used with a number of licensing business models, such as, for example, a non-renewable evaluation license, a renewable trial license, a one-time promotion license, a subscription license, or other time-based licenses. The configurable parameters, according to FIG. 4, may include activations per machine, number of machines, extended grace, absolute start/end date, language, number of activations, validity units, grace activations, activations before perpetual, activation threshold, and geography. In some embodiments, the configurable parameters may be configured on a per-time-based-license-type basis or on a per-product-key basis.

Activations per machine may be a numeric value indicating a number of activations per machine for a time-based license. For example, activations per machine may be 5, or another value, for each time-based license of a particular type or associated with a particular product key.

Number of machines may be a numeric value indicating a number of machines, or processing devices, that may have an activated time-based license including a same product key. In some embodiments, number of machines may be 0 for class A and class C licenses and may be 1 for class B and class D licenses.

Extended grace may be a numeric value indicating a number of time units that a software product, associated with a time-based license, may continue to be used before full operation of the software product may be prevented after the time-based license would normally have expired. The time units may be in minutes, or another suitable time unit. According to FIG. 4, class A licenses may not have a period of extended grace, while licenses of classes B, C, and D may have a period of extended grace. For example, class B licenses and class C licenses may have a seven day extended grace period, and class D licenses may have a 30 day extended grace period. Of course, in other embodiments, other time periods of extended grace may be employed.

Absolute start/end date may include an absolute start date and an absolute end date. The absolute start date may include a date and time before which a time-based license having a particular product key may be invalid, regardless of any prior activation. The absolute end date may include a date and time after which a time-based license having a particular product key may be invalid, regardless of any prior activation. According to FIG. 4, all classes of time-based licenses may have an absolute start/end date.

Language may indicate a time-based license activation restriction based on language. According to FIG. 4, all classes of time-based licenses may have a language activation restriction. For example, any class of time-based license may be restricted to use with software products of a particular language, such as, for example, English, and/or other languages.

Number of activations may be a total number of activations permitted per type of time-based license. According to FIG. 4, class A and class C time-based licenses may have a total of 1 activation, while class B and class D licenses may be configured to another numerical value, such as, for example, 2, or another value.

Validity units may be a number of time interval increments, in a particular time unit, that a time-based license may be activated or valid. The particular time unit may be in minutes, hours, or another time period. Validity units may be configurable for all classes of time-based licenses. In one embodiment, for example, validity units may be a number of time intervals in a 180 day period for class A time-based licenses, a number of time intervals in a 30 day period for class B time-based licenses, a number of time intervals in a 90 day period for class C time-based licenses, and a number of time intervals in a 360 day period for class D time-based licenses. Of course, in other embodiments, other time periods may be used for different classes of time-based licenses.

Grace activations may be a number of grace activations allowed for a time-based license and typically, may be set by a customer service representative. Grace activations may permit a time-based license to be activated after the time-based license has been activated a maximum permitted total number of times, or a maximum permitted total number of times for a machine or processing device. Typically, grace activations may be set to 0 until a customer service representative changes a value of grace activations for a time-based license.

Activations before perpetual may be a number of activations of a time-based license before the time-based license may be automatically transitioned to a perpetual license. According to FIG. 4, activations before perpetual may be configured for class B and class D time-based licenses. In one embodiment, activations before perpetual may be set to 100 for class B and class D time-based licenses. Thus, for example, a class B time-based license may become a perpetual license after 100 activations. Of course, activations before perpetual may be set to another value.

Activation threshold may be a percentage of initial validity units before expiration or an absolute number of validity units before expiration, such that a re-activation would increment validity units for a time-based license to a next activation expiration. For example, if a time-based license has an activation threshold of 30, then a re-activation of the time-based license would only add validity units to a next activation expiration when no more than 30 validity units remain before expiration. A reactivation of the time-based license when a number of validity units remaining is greater than the activation threshold may not add any activation time to the time-based license. According to FIG. 4, class B and class C time-based licenses may have a configurable activation threshold. In one embodiment, class B and class C licenses may have an activation threshold of 25% of the initial validity units.

Geography may refer to a geographic region in which a time-based license may be valid. The time-based license may be invalid outside of the geographic region. For example, a time-based license may have a value of geography set to indicate that the time-based license is valid only in the United States. According to FIG. 4, all classes of time-based licenses may permit geography to be configured.

In one embodiment consistent with the subject matter of this disclosure, class A time-based licenses may be used as non-renewable evaluation licenses, class B time-based licenses may be used as renewable trial licenses, class C time-based licenses may be used as one-time promotion licenses, and class D licenses may be used as subscription licenses. Of course, in other embodiments the different classes of time-based licenses may be used for other types of licenses.

### Exemplary Processes

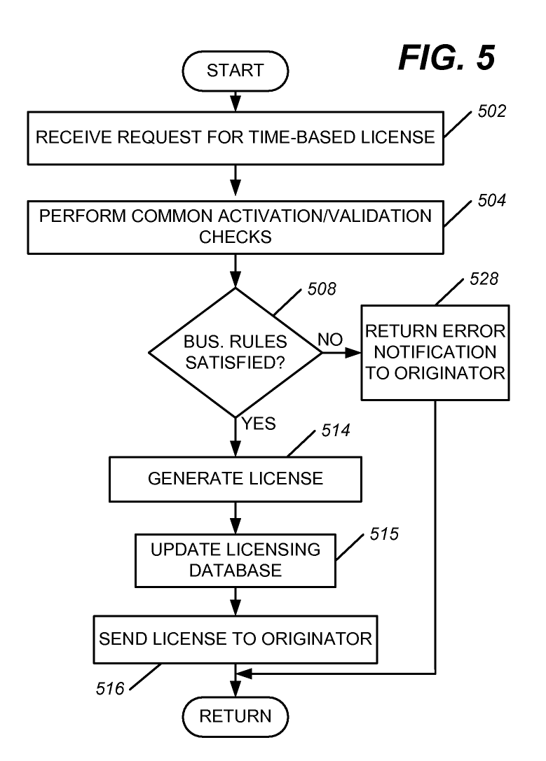

FIG. 5 illustrates a flowchart of an exemplary process which may be performed in an embodiment of activation server 310. The process may begin with activation server 310 receiving a request for a time-based license, which may include a product key from an originating processing device, such as, for example, licensing platform 302 within second processing device 106 (act 502). Activation server 310 may then perform common activation/validation checks on the received request (act 504).

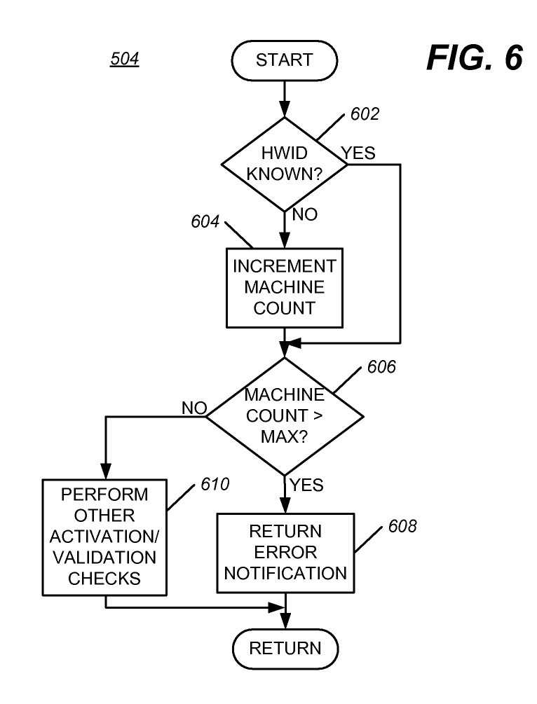

FIG. 6 is a flowchart illustrating an exemplary process for performing act 504 in an embodiment of activation server 310. The process may begin with activation server 310 determining whether a hardware ID, corresponding to the originating processing device and included in the received request, is known with respect to a license associated with the product key (act 602). If the hardware ID is known, then activation server 310 may increment a machine count for keeping track of a number of machines associated with a license for executing a product identified by the product key (act 604).

After performing act 604 to increment machine count, or after performing act 602 and determining that the hardware ID is known, activation server 310 may determine whether machine count is greater than a particular maximum value (act 606). If machine count is determined to be greater than the particular maximum value, then activation server 310 may return an error notification (act 608). Otherwise, activation server 310 may perform other activation/validation checks, such as, for example, determining whether the product key is valid and/or additional activation/validation checks (act 610). A failure of any of the other activation/validation checks performed during act 610 may result in an error notification being returned.

Returning to FIG. 5, activation server 310 may then determine whether business rules are satisfied (act 508).

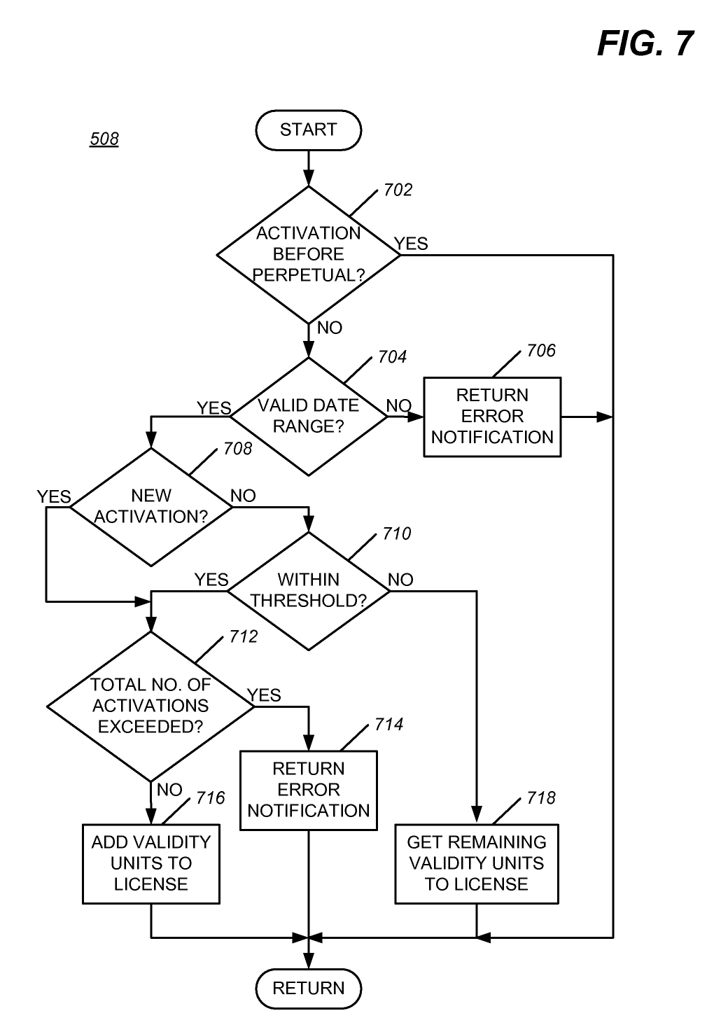

FIG. 7 is a flowchart illustrating an exemplary process for performing act 508 in an embodiment of activation server 310. The process may begin with activation server 310 determining whether a perpetual license is to be generated because the “activation before perpetual” condition is satisfied (see FIG. 4) with respect to a license associated with the product key (act 702). If the “activation before perpetual” condition is determined to be satisfied, then a perpetual license may be generated later during act 514 (FIG. 5). The remaining validity units of the license may remain unchanged and the process may be completed. Otherwise, if the “activation before perpetual” condition is determined to be unsatisfied, then a time-based license may be generated later during act 514 (FIG. 5). Activation server 310 may then determine whether the request for the time-based license occurred within a valid date range (act 704). Activation server 310 may make the determination by comparing a current date and time with an absolute starting and ending date associated with the license.

If the request for the time-based license did not occur within the valid date range, then activation server 310 may return an error notification (act 706) and the process may be completed. Otherwise, activation server 310 may determine whether the request includes a request for a new activation (act 708). If the request does not include a request for a new activation, then the request may be a request to renew a time period for a time-based license. Activation server 310 may then determine whether the request to renew the time period occurred within an activation threshold, as previously described (act 710). If the request to renew the time period did not occur within the activation threshold, then activation server 310 may provide a remaining number of validity units to the time-based license (act 718). In other words, no additional validity units are added to the time-based license.

If, during act 708, activation server 310 determines that the request includes a request for a new activation, or if during act 710, activation server 310 determines that a received request to renew a time period for the time-based license occurred within the activation threshold, then activation server 310 may determine whether a total number of activations, with respect to the time-based license, has been exceeded (act 712). If the total number of activations, with respect to the time-based license, has been exceeded, then activation server 310 may return an error notification (act 714). Otherwise, a number of validity units may be added to the time-based license. The process may then be completed.

Returning to act 508 (FIG. 5), if the business rules are determined to not be satisfied due to an error notification being returned, then activation server 310 may return an error notification to the originating processing device (act 528), which may display an error message via a user interface. If, during act 508, the business rules are determined to be satisfied, then activation server 310 may generate a time-based license, or a perpetual license if the “activation before perpetual” condition is satisfied (see FIG. 4) (act 514). Activation server 310 may determine a type of time-based license to generate based on information stored in the licensing database with respect to a product key included in the request for the time-based license. Activation server 310 may then update information in licensing database 312, such as, for example, hardware ID, machine count, activation count and/or other information (act 515). The generated license may then be sent to the originating processing device (act 516) and the process may be completed.

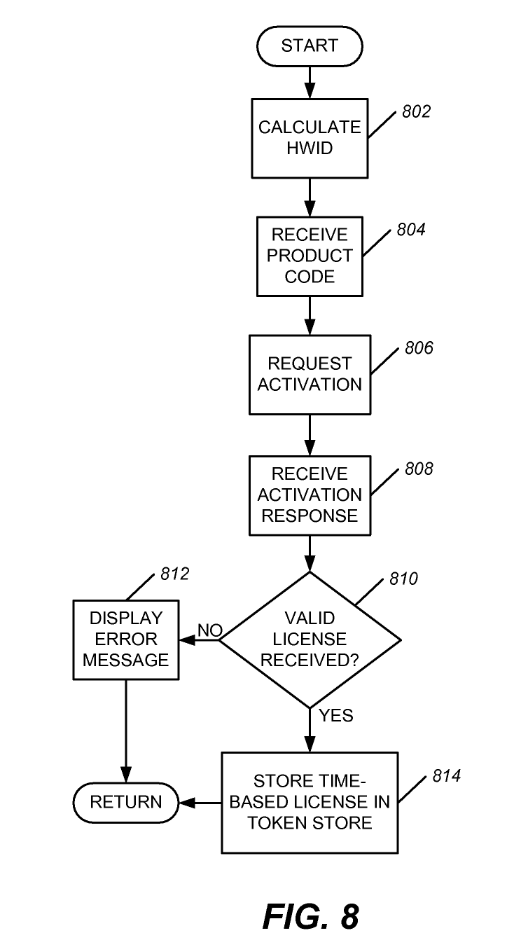

FIG. 8 illustrates an exemplary process which may be performed by licensing platform 302 included in second processing device 106. The process may begin with licensing platform 302 calculating a hardware ID for second processing device 106 (act 802). In one embodiment consistent with the subject matter of this disclosure, the hardware ID may be a generated hash code based on a number of hardware components of second processing device 106, such as, for example, an amount of memory, an amount of storage on a storage device, a type of processor, and/or a configuration of other hardware components.

Licensing platform 302 may then receive a product key corresponding to a product to be activated (act 804). The product code may be received from a user, via a user interface, or may be received from an application via licensing API 304. Licensing platform 302 may then request activation of a time-based license corresponding to the product code by sending the request to activation server 310 (act 806). Activation server 310 may receive and process the request as previously described with respect to FIGS. 5-7.

Licensing platform 302 may then receive an activation response from activation server 310 (act 808). The activation response may include a time-based license corresponding to the product key, or may include an error notification, as previously described.

Licensing platform 302 may then determine whether the activation response includes a valid license (act 810). Licensing platform 302 may determine the validity of a received license by determining whether a checksum, calculated over the received license, is valid, whether configurable parameters associated with the license have valid values or settings, and/or via other methods.

If the received license is determined not to be valid, then licensing platform 302 may display an error message to a user via a user interface (assuming that the user originated the request for a time-based license), or licensing platform 302 may return an error code to an application via licensing API 304 (assuming that the application originated the request for a time-based license) (act 812).

If, during act 810, licensing platform 302 determined that the received activation response includes a valid license, then licensing platform 302 may store the time-based license in a token store (act 814). The stored time-based license may include rights for associated applications to be fully functional.

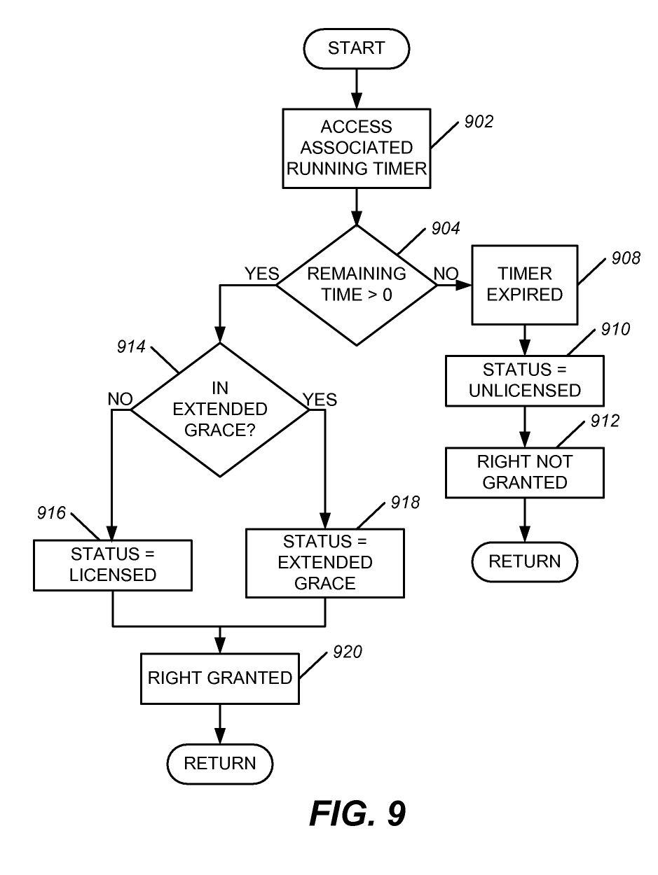

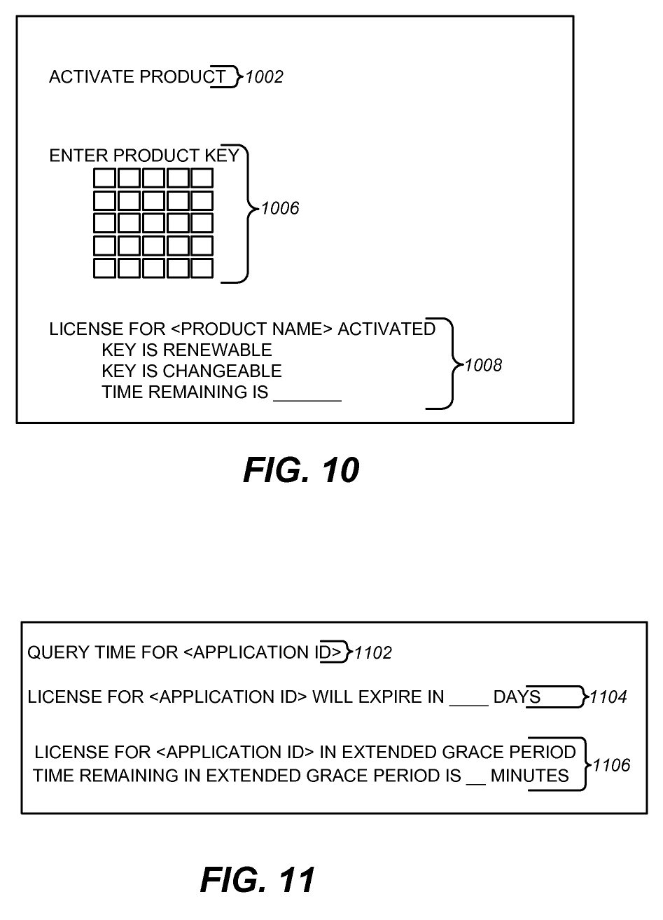

FIG. 9 is a flowchart which illustrates an exemplary process for processing a running timer associated with a time-based license in licensing platform 302 to determine whether the time-based license is still valid. The process may begin by licensing platform 302 accessing the running time associated with the time-based license (act 902).

Licensing platform 302 may then determine whether the time-based license has any remaining time (act 904). If the time-based license has no remaining time, then the running timer expired (act 908). Licensing platform 302 may then set a status, with respect to the time-based license, to unlicensed (act 910). A right to execute one or more applications associated with the time-based license may then not be granted (act 912).

If, during act 904, licensing platform 302 determined that the time-based license has remaining time, then licensing platform 302 may determine whether the time-based license is in an extended grace period (act 914). If the time-based license is determined to be in an extended grace period, then the status, with respect to the time-based license, may be set to licensed (act 916). A right to execute the one or more applications associated with the time-based license may then be granted (act 920).

### Exemplary User Interface

FIG. 11 illustrates exemplary commands, which may be entered via a user interface executing on second processing device 106, and exemplary messages, which may be displayed via the user interface. A user may enter an activate product command 1002 when the user wishes to activate or renew a license for a software product. Upon entering command 1002, via the user interface, licensing platform 302 may display product key prompt 1006, prompting the user to enter a product key, which may be a 5×5 key, or another type of key. After a time-based license is renewed or activated, a license activation message 1008 may be displayed stating a product name, corresponding to the activated time-based license, whether a product key of the time-based license is renewable and/or changeable, and an amount of time remaining before the time-based license expires. In other embodiments, different or other messages may be displayed and different or other commands may be entered.

In some embodiments consistent with the subject matter of this disclosure, a user may query, via a user interface, an amount of time remaining before expiration of a time-based license associated with an application. Message 1102 (FIG. 12) is an example of such a query. Further, a message may be displayed at certain time intervals before expiration of a time-based license indicating that the time-based license will soon expire. Message 1104 is an example of such a message, stating that a license for a particular application will expire in a particular number of time periods, such as, for example, days, or another time period. Message 1106, indicating that a license for a particular application is in an extended grace period, may be displayed when a time-based license is in an extended grace period and may further display an amount of time units remaining in the extended grace period. The time units may be in minutes, or another time period.

The above mentioned examples, configuration parameters, and classes of time-based licenses are only exemplary. In other embodiments, additional, or other configuration parameters and classes of time-based licenses may be employed.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents define the scope of the invention, rather than any specific examples given.

We claim as our invention:

1. A machine-implemented method for licensing a software product, the machine-implemented method comprising:
generating a time-based license from among a plurality of types of time-based licenses in response to receiving a request for the time-based license, each of the plurality of types of time-based licenses having a plurality of configurable parameters, a combination of the plurality of types of time-based licenses and the plurality of configurable parameters being capable of accommodating a plurality of licensing business models; and
sending the time-based license to an originating processing device of the request for the time-based license.

2. The machine-implemented method of claim 1, wherein:
at least one of the types of time-based licenses is renewable; and
at least one of the types of time-based licenses is nonrenewable.

3. The machine-implemented method of claim 1, wherein the plurality of configurable parameters include a parameter indicating a number of activations per processing device.

4. The machine-implemented method of claim 1, wherein:
each of the types of time-based licenses is associated with a range of product keys, and
the plurality of configurable parameters include a parameter indicating a number of processing devices that can activate a time-based license using a same product key.

5. The machine-implemented method of claim 1, wherein the plurality of configurable parameters for at least some of the types of time-based licenses include a parameter indicating a number of activations before an automatic transition to a perpetual license.

6. The machine-implemented method of claim 1, wherein:
each of the types of time-based licenses is associated with a range of product keys, and
the plurality of configurable parameters include a parameter indicating whether a product key associated with respective time-based licenses is changeable.

7. The machine-implemented method of claim 1, wherein:
each of the types of time-based licenses is associated with a range of product keys, and
the plurality of configurable parameters include a first parameter indicating a first date before which a respective time-based license is invalid and a second parameter indicating a second date after which the respective time-based license is invalid.

8. A processing device for generating a time-based license in response to receiving a request for the time-based license, the processing device comprising:
at least one processor; and
a memory connected to the at least one processor, the memory comprising:
instructions for generating the time-based license, a type of the time-based license being based on a product key included in the request for the time-based license, the generated time-based license having a plurality of configurable parameters defining a plurality of properties of the generated time-based license, a combination of the plurality of types and the plurality of configurable parameters being capable of accommodating a plurality of licensing business models, and
instructions for sending the generated time-based license to a second processing device that originated the request for the time-based license.

9. The processing device of claim 8, wherein:
time-based licenses are associated with a respective product key,
time-based licenses of at least a first one of a plurality of types permit a change of the associated respective product key, and
time-based licenses of at least a second one of the plurality of types permit renewal of respective time-based licenses without a change of associated respective product keys.

10. The processing device of claim 8, wherein the memory further comprises:
instructions for changing properties of a time-based license by changing configurable parameters of the time-based license on a per-product-key basis or on a per-time-based-license-type basis.

11. The processing device of claim 8, wherein the memory further comprises instructions for renewing a validity interval of a time-based license according to at least one configurable parameter of the time-based license.

12. The processing device of claim 8, wherein the memory further comprises instructions for enforcing selective properties of the time-based license as defined by the plurality of configurable parameters.

13. The processing device of claim 8, wherein the memory further comprises instructions for changing a type of a license from a first type to a second type.

14. The processing device of claim 8, wherein the memory further comprises instructions for changing a time-based license to a perpetual license based on a number of activations of the time-based license.

15. A tangible machine-readable medium having instructions recorded thereon for at least one processor, the instructions comprising:
instructions for validating and using a received time-based license of any one of a plurality of types, the time-based license having a plurality of configurable parameters defining properties of the time-based license; and
instructions for displaying, an amount of time before a valid time-based license expires.

16. The tangible machine-readable medium of claim 15, wherein the instructions further comprise instructions for providing a user interface to permit a user to enter time-based license commands and to view information with respect to a time-based license.

17. The tangible machine-readable medium of claim 15, wherein the instructions further comprise instructions for displaying to a user a message warning of an impending license expiration at predetermined time periods before a time-based license expires.

18. The tangible machine-readable medium of claim 15, wherein the instructions further comprise:
instructions for granting a right to use a fully enabled software product associated with the time-based license when the time-based license has remaining time, and
instructions for not granting the right to use the fully enabled software product when the time-based license has no remaining time.

19. The tangible machine-readable medium of claim 15, wherein the instructions further comprise:
instructions for displaying information regarding a time-based license, and
instructions for executing the instructions for displaying an amount of time before a valid time-based license expires, at a predetermined time period before expiration of the valid time-based license.

20. The tangible machine-readable medium of claim 15, wherein the instructions further comprise:
instructions for providing an application program interface for an application to request activation of a time-based license.
